(19) United States
(12) Patent Application Publication
(10) Pub. No.: US 2024/0384704 A1
(43) Pub. Date: Nov. 21, 2024

(54) RENEWABLE ENERGY PREDICTION METHODS AND SYSTEMS

(71) Applicants: KRISTEN RENE SCHELL, KINBURN (CA); FARZAD ROOZITALAB, OTTAWA (CA)

(72) Inventors: KRISTEN RENE SCHELL, KINBURN (CA); FARZAD ROOZITALAB, OTTAWA (CA)

(21) Appl. No.: 18/662,167

(22) Filed: May 13, 2024

Related U.S. Application Data
(60) Provisional application No. 63/502,738, filed on May 17, 2023.

(51) Int. Cl. F03D 17/00

(52) U.S. Cl. CPC F03D 17/006; F05B 2260/821; F05B 2270/709

(57) ABSTRACT

Renewable energy provides humanity with a means of harvesting natural phenomena. However, the generating means are typically non-linear and the natural phenomenon variable such that the resulting electrical output is similarly variable and difficult to predict impacting their operators as well as consumers, regulators, planners, government bodies, etc. It would be beneficial therefore to provide engineers, infrastructure operators, regulators, planners etc. with a framework that allows for the electrical output from specific elements of infrastructure to be predicted. This framework being implantable, for example, through software processes and methods either associated with the elements of infrastructure or independent from the elements of infrastructure.

### CROSS-REFERENCE TO RELATED APPLICATIONS

This patent application claims the benefit of priority from U.S. Provisional Patent Application 63/502,738 filed May 17, 2023; the entire contents of which are incorporated herein by reference.

### FIELD OF THE INVENTION

This patent application relates to renewable energy and more particularly to methods and processes for forecasting electrical power generation of renewable energy infrastructure.

### BACKGROUND OF THE INVENTION

Renewable energy provides humanity with a means of harvesting natural phenomena, such as water flow, air flow, and sunlight, to generate electricity for consumption. Renewable energy has increasingly become a focus for research, development and deployment to overcome reducing physical natural resources such as oil and coal and limit the environmental damage/impact arising from the burning of such physical natural resources.

However, a natural phenomenon such as air flow presents obstacles above those typically considered by society such as cost, location, and environmental impact. The generating means are typically non-linear and the natural phenomenon, e.g. wind, variable, e.g. speed and direction for wind. The resulting electrical output from elements of infrastructure generating electricity by harvesting natural phenomena therefore variable and difficult to predict which impacts their operators as well as consumers receiving electricity from these operators either directly or indirectly through intermediate enterprises/infrastructure. It can also impact regulators, planners, government bodies, etc.

Accordingly, it would be beneficial to provide engineers, infrastructure operators, regulators, planners etc. with a framework that allows for the electrical output from specific elements of infrastructure to be predicted. This framework being implantable, for example, through software processes and methods either associated with the elements of infrastructure or independent from the elements of infrastructure.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to renewable energy and more particularly to methods and processes for forecasting electrical power generation of renewable energy infrastructure.

In accordance with an embodiment of the invention there is provided a method of predicting an output of a wind farm comprising:
training a deep learning time-series forecasting model;
providing input data to the deep learning time-series forecasting model; and
establishing an output from the deep learning time-series forecasting model.

In accordance with an embodiment of the invention there is provided a system comprising:
one or more microprocessors; and
one or more memories storing:
   spatial information of a plurality of meteorological stations;
   acquired environmental measurements from each meteorological station of the plurality of meteorological stations over a period of time;
   spatial information of a wind farm; and
   output information of the wind farm over the period of time; wherein
the one or more processors provide a deep learning time-series forecasting model;
the deep learning time-series forecasting model is trained using the spatial information of the plurality of meteorological stations, the environmental measurements from each meteorological station of the plurality of meteorological stations over a subset of the period of time, the spatial information of the wind farm and output information of the wind farm over the subset of the period of time;
providing to the deep learning time-series forecasting model environmental measurements from each meteorological station of the plurality of meteorological stations over another subset of the period of time; and
generating from the deep learning time-series forecasting model a prediction of the output of the wind farm for a predetermined forecast window from an end point of the period of time.

In accordance with an embodiment of the invention there is provided a non-transitory storage medium storing computer executable instructions, the computer executable instructions when executed by one or more processors cause the one or more processors to execute a process comprising:
executing a deep learning time-series forecasting model;
training the deep learning time-series forecasting model with spatial information of a plurality of meteorological stations, environmental measurements from each meteorological station of the plurality of meteorological stations over a subset of a period of time, spatial information of a wind farm and output information of the wind farm over a period of time; and
generating from the deep learning time-series forecasting model a prediction of the output of the wind farm for a predetermined forecast window in dependence upon other environmental measurements from each meteorological station of the plurality of meteorological stations over another period of time.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary network environment within which configurable electrical devices according to and supporting embodiments of the invention may be deployed and operate; and

FIG. 2 depicts an exemplary wireless portable electronic device supporting communications to a network such as depicted in FIG. 1 and configurable electrical devices according to and supporting embodiments of the invention;

FIG. 3 depicts an exemplary geographical representation of a network of meteorological stations and windfarms to which methods and processes according to embodiments of the invention can be applied;

FIG. 4 depicts a model architecture according to an embodiment of the invention;

FIG. 5 depicts performance of a wind power forecast model according to an embodiment of the invention for a 12-hour prediction versus prior art models;

FIG. 6 depicts performance of a wind power forecast model according to an embodiment of the invention for a 12-hour prediction for two wind farms in different seasons; and

FIG. 7 depicts integrated gradient analysis for a sample prediction made with a wind power forecast model according to an embodiment of the invention for a 12-hour prediction.

### DETAILED DESCRIPTION

The present invention is directed to renewable energy and more particularly to methods and processes for forecasting electrical power generation of renewable energy infrastructure.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and one or more items of instrumentation and/or equipment forming part of a meteorological station or other equipment providing one or more sets of information provide information relating to the local atmospheric conditions at the FED.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, a multimedia player and one or more items of instrumentation and/or equipment forming part of a meteorological station or other equipment providing one or more sets of information provide information relating to the local atmospheric conditions at the FED.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

A “meteorological station” or “weather station” as used herein refers to, but is not limited to, a facility, typically on land or sea, with one or more instruments and/or equipment for measuring atmospheric conditions to provide information relating to the local atmospheric conditions at the meteorological station. The one or more instruments may include, but not be limited, to a thermometer or temperature sensor for measuring air and/or sea surface temperature, a barometer for measuring atmospheric pressure, a hygrometer for measuring humidity, an anemometer for measuring wind speed, a pyranometer for measuring solar radiation, a rain gauge for measuring liquid precipitation over a set period of time, a windsock for measuring general wind speed and wind direction and a wind vane for wind direction. Multiple anemometers with appropriate shielding may also provide wind direction as well as wind speed. Such meteorological stations may include, but not be limited to, personal weather stations, home weather stations, weather buoys, weather stations attached to buildings or renewable energy infrastructure and dedicated weather stations. A meteorological station may transmit data continuously, periodically or in response to a request in a predetermined format, such as METAR for example or another format, where the received data may be directly stored or stored after being translated/converted.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

An “organization” as used herein may refer to, but is not limited to, an entity such as a company, an institution or an association comprising one or more people with a defined purpose. An organization may therefore include, but not be limited to, one or more of a user, a third-party provider, a service provider, an enterprise, a Government entity and a regulatory body.

A “regulator” or “regulatory agency” as used herein may refer to, but is not limited to, an authority that is responsible for exercising autonomous dominion over some area of human activity in a licensing and regulating capacity. The regulator may be directly controlled by a government or it may be an independent agency (independent regulatory agency or independent regulator) empowered to exercise autonomous dominion over some area of human activity in a licensing and regulating capacity. Such empowerment may be as a result of a governmental edict or an act of law. Such regulators may be jurisdictional, e.g. provincial, state, national or regional, or international.

An “artificial intelligence system” (referred to hereafter as artificial intelligence, AI) as used herein, and throughout disclosure, refers to machine intelligence or machine learning in contrast to natural intelligence. An AI may refer to analytical, human inspired, or humanized artificial intelligence. An AI may refer to the use of one or more machine learning algorithms and/or processes. An AI may employ one or more of an artificial network, decision trees, support vector machines, Bayesian networks, and genetic algorithms. An AI may employ a training model or federated learning.

“Machine Learning” (ML) or more specifically machine learning processes as used herein refers to, but is not limited, to programs, algorithms or software tools, which allow a given device or program to learn to adapt its functionality based on information processed by it or by other independent processes. These learning processes are in practice, gathered from the result of said process which produce data and or algorithms that lend themselves to prediction. This prediction process allows ML-capable devices to behave according to guidelines initially established within its own programming but evolved as a result of the ML. A machine learning algorithm or machining learning process as employed by an AI may include, but not be limited to, supervised learning, unsupervised learning, cluster analysis, reinforcement learning, feature learning, sparse dictionary learning, anomaly detection, association rule learning, inductive logic programming.

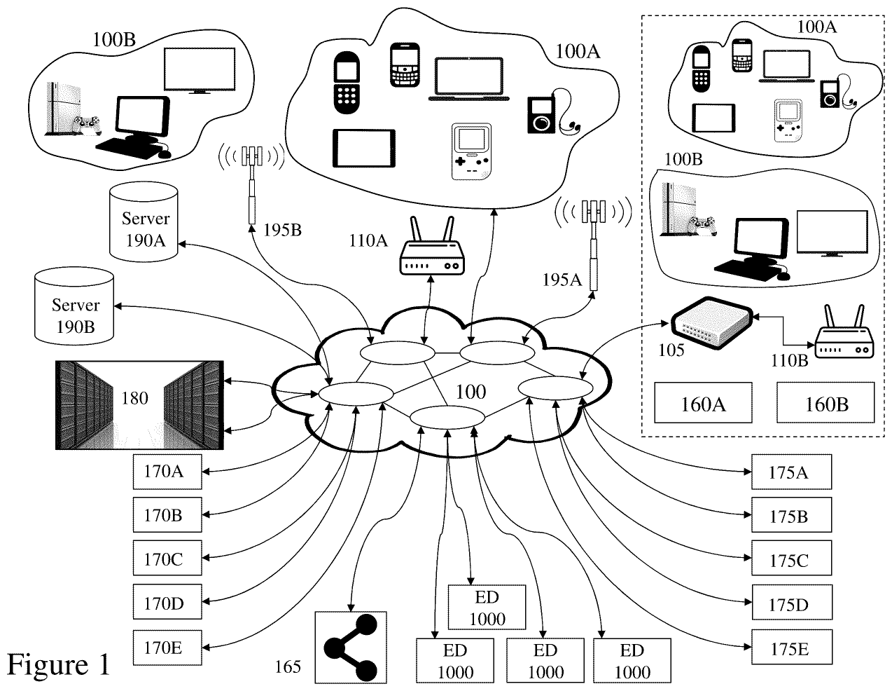

Referring to FIG. 1 there is depicted a Network 100 within which embodiments of the invention may be employed supporting Predictive Renewable Energy (PRE) Systems, Applications and Platforms (PRE-SAPs) according to embodiments of the invention. Such PRE-SAPs, for example, supporting multiple communication channels, dynamic filtering, etc. As shown first and second user groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second user groups 100A and 100B respectively. Also connected to the Network 100 are first and second Wi-Fi nodes 110A and 110B, the latter of which being coupled to Network 100 via Router 105. Second Wi-Fi node 110B is associated with Enterprise 160, comprising other first and second user groups 100A and 100B. Second user group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first AP 195A and/or first Wi-Fi node 110A the first group of users 100A may employ a variety of PEDs. Within the cell associated with second AP 195B the second group of users 100B which may employ a variety of FEDs. First and second cellular APs 195A and 195B respectively provide, for example, cellular GSM (Global System for Mobile Communications) telephony services as well as 3G and 4G evolved services with enhanced data transport support. The first and second user groups 100A and 100B may be geographically disparate and access the Network 100 through multiple APs, not shown for clarity, distributed geographically by the network operator or operators. First cellular AP 195A as shown provides coverage to first user group 100A and Enterprise 160, which comprises another second user group 100B as well as another first user group 100A. Accordingly, the first and second user groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 100A may form associations either through standards such as IEEE 802.15 or Bluetooth as well in an ad-hoc manner.

Also connected to the Network 100 are one or more Social Networks (SOCNETS) 165, first and second service providers 170A and 170B respectively, first and second third party service providers 170C and 170D respectively, and a user 170E. Also connected to the Network 100 are first and second Enterprises 175A and 175B respectively, first and second Organizations 175C and 175D respectively, and a Government Entity 175E. Also depicted are first and second Servers 190A and 190B may host according to embodiments of the inventions multiple services associated with a provider of Predictive Renewable Energy (PRE) Systems, Applications and Platforms (PRE-SAPs); a provider of a SOCNET exploiting PRE-SAP features; a regulator exploiting PRE-SAP features; an organization exploiting PRE-SAP features; a provider of services (service provider) exploiting PRE-SAP features; a provider of one or more aspects of wired and/or wireless communications; a third-party provider exploiting PRE-SAP features; an Enterprise 160 exploiting PRE-SAP features; license databases; content databases; image databases; content libraries; customer databases; websites; and software applications for download to or access by FEDs and/or PEDs exploiting and/or hosting PRE-SAP features. First and second Servers 190A and 190B may also host for example other Internet services such as a search engine, financial services, third party applications and other Internet based services.

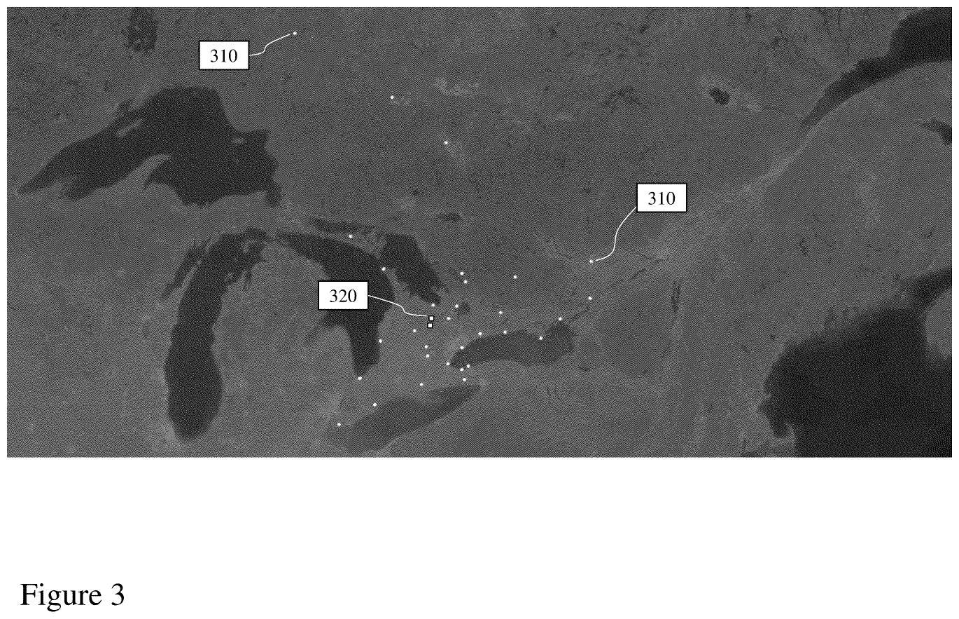

Also depicted in FIG. 1 are Electronic Devices (EDs) 100 according to embodiments of the invention such as described and depicted below in respect of FIG. 3. As depicted in FIG. 1 the EDs 100 communicate directly to the Network 100. The EDs 100 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a user may exploit a PED and/or FED within an Enterprise 160, for example, and access one of the first or second Servers 190A and 190B respectively to perform an operation such as accessing/downloading an application which provides PRE-SAP features according to embodiments of the invention; execute an application already installed providing PRE-SAP features; execute a web based application providing PRE-SAP features; or access content. Similarly, a user may undertake such actions or others exploiting embodiments of the invention exploiting a PED or FED within first and second user groups 100A and 100B respectively via one of first and second cellular APs 195A and 195B respectively and first Wi-Fi node 110A. It would also be evident that a user may, via exploiting Network 100 communicate via telephone, fax, email, SMS, social media, etc.

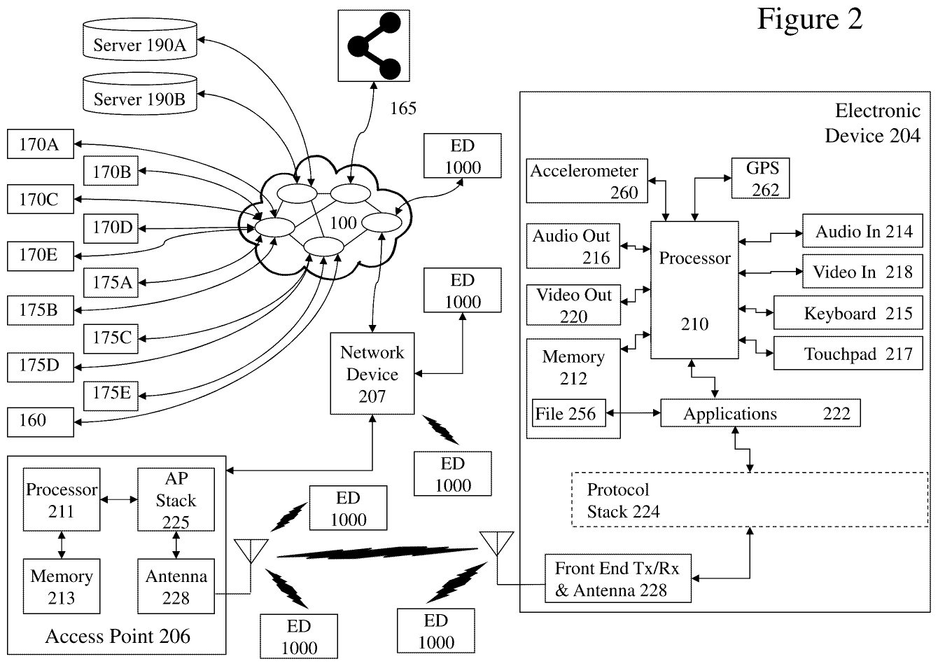

Now referring to FIG. 2 there is depicted an Electronic Device 204 and network access point 207 supporting PRE-SAP features according to embodiments of the invention. Electronic Device 204 may, for example, be a PED and/or FED and may include additional elements above and beyond those described and depicted. Electronic Device 204 may form part of one or more items of instrumentation and/or equipment forming part of a meteorological station or other equipment providing one or more sets of information provide information relating to the local atmospheric conditions to the Electronic Device 204 and therein, for example, to a database or application in execution upon one of the first and second Servers 190A and 190B. Alternatively, Electronic Device 204 may interface with one or more items of instrumentation and/or equipment forming part of a meteorological station or other equipment providing one or more sets of information provide information relating to the local atmospheric conditions.

Also depicted within the simplified functional diagram of a system that includes the Electronic Device 204, such as a PED or FED, an access point (AP) 206, such as first AP 195A, and one or more Network Devices 207, such as communication servers, streaming media servers, and routers for example such as first and second Servers 190A and 190B respectively. Network Devices 207 may be coupled to AP 206 via any combination of networks, wired, wireless and/or optical communication links such as discussed above in respect of FIG. 1 as well as directly as indicated. Network Devices 207 are coupled to Network 100 and therein Social Networks (SOCNETS) 165, first and second service providers 170A and 170B respectively, first and second third party service providers 170C and 170D respectively, a user 170E, first and second enterprises 175A and 175B respectively, first and second organizations 175C and 175D respectively, and a government entity 175E.

The Electronic Device 204 includes one or more processors 210 and a memory 212 coupled to processor(s) 210. AP 206 also includes one or more processors 211 and a memory 213 coupled to processor(s) 210. A non-exhaustive list of examples for any of processors 210 and 211 includes a central processing unit (CPU), a graphical processing unit (GPU), a digital signal processor (DSP), a reduced instruction set computer (RISC), a complex instruction set computer (CISC) and the like. Furthermore, any of processors 210 and 211 may be part of application specific integrated circuits (ASICs) or may be a part of application specific standard products (ASSPs). A non-exhaustive list of examples for memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an audio output element 216, for example, a speaker, coupled to any of processors 210. Electronic Device 204 may include a video input element 218, for example, a video camera or camera, and a video output element 220, for example an LCD display, coupled to any of processors 210. Electronic Device 204 also includes a keyboard 215 and touchpad 217 which may for example be a physical keyboard and touchpad allowing the user to enter content or select functions within one of more applications 222. Alternatively, the keyboard 215 and touchpad 217 may be predetermined regions of a touch sensitive element forming part of the display within the Electronic Device 204. The one or more applications 222 that are typically stored in memory 212 and are executable by any combination of processors 210. Electronic Device 204 also includes accelerometer 260 providing three-dimensional motion input to the process 210 and GPS 262 which provides geographical location information to processor 210. Optionally, the ED 204 may employ a wireless triangulation to establish geographical location.

Electronic Device 204 includes a protocol stack 224 and AP 206 includes a communication stack 225. Within the system depicted in FIG. 2 protocol stack 224 may, for example, be an IEEE 802.11 protocol stack but alternatively may exploit other protocol stacks such as an Internet Engineering Task Force (IETF) multimedia protocol stack for example. Likewise, AP stack 225 exploits a protocol stack. Elements of protocol stack 224 and AP stack 225 may be implemented in any combination of software, firmware and/or hardware. Applications 222 may be able to create maintain and/or terminate communication sessions with any Network Devices 207 by way of AP 206.

It would be apparent to one skilled in the art that elements of the Electronic Device 204 may also be implemented within the AP 206 including but not limited to one or more elements of the protocol stack 224. Portable and fixed electronic devices represented by Electronic Device 204 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Also depicted in FIG. 2 are Electronic Devices (EDs) 100 which may communicate directly to the Network 100 or they may communicate to the Network Device 207, Access Point 206, and Electronic Device 204. Some EDs 100 may communicate to other EDs 100 directly. Within FIG. 2 the EDs 100 coupled to the Network 100 and Network Device 207 communicate via wired interfaces. The EDs 100 coupled to the Access Point 206 and Electronic Device 204 communicate via wireless interfaces. Each ED 100 may communicate to another electronic device, e.g. Access Point 206, Electronic Device 204 and Network Device 207, or a network, e.g. Network 100. Each ED 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

An ED 100 may form part of one or more items of instrumentation and/or equipment forming part of a meteorological station or other equipment providing one or more sets of information provide information relating to the local atmospheric conditions communicating with an Electronic Device 204 and therein providing data, for example, to a database or application in execution upon one of the first and second Servers 190A and 190B or upon the Electronic Device 204. Alternatively, an ED 100 may form part of one or more items of instrumentation and/or equipment forming part of a meteorological station or other equipment providing one or more sets of information provide information relating to the local atmospheric conditions directly to a database or application in execution upon one of the first and second Servers 190A and 190B or another Electronic Device 204 via the Network 100.

Optionally, rather than wired and./or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

As outlined previously renewable energy provides humanity with a means of harvesting natural phenomena, such as water flow, air flow, and sunlight, to generate electricity for consumption. However, a natural phenomenon such as air flow presents obstacles above those typically considered by society such as cost, location, and environmental impact. The generating means are typically non-linear and the natural phenomenon, e.g. wind, variable, e.g. speed and direction for wind. The resulting electrical output from elements of infrastructure generating electricity by harvesting natural phenomena therefore variable and difficult to predict which impacts their operators as well as consumers receiving electricity from these operators either directly or indirectly through intermediate enterprises/infrastructure. It can also impact regulators, planners, government bodies, etc.

Within the following description embodiments of the invention are described and depicted with respect to wind power as a source of providing energy, renewable energy. However, the embodiment(s) of the invention are not limited to wind power which are provided as representative embodiment(s) only, and is (are) not intended to limit the scope, applicability or configuration of the disclosure. Rather, the ensuing description of the embodiment(s) will provide those skilled in the art with an enabling description for implementing an embodiment or embodiments of the invention which may be applied to other energy generation means. The scope of the invention being defined by the claims appended hereto.

Wind power forecasting (WPF) is a challenging time-series forecasting task due to the non-linear, dynamic nature of wind farms and the chaotic nature of atmospheric wind speeds and directions. Previous studies have often relied on proprietary, facility-specific wind farm data to advance WPF models. In contrast, the inventors have developed an improved forecasting model utilizing only open source wind farm output power and meteorological data from weather stations located throughout the wind farms' region. The inventors have established a new deep learning architecture, which they refer to as WindCTD, which is capable of capturing regional spatial information and weather patterns. By exploiting, within an embodiment of the invention, a CNN-Transformer-Dense architecture the inventors have established a model which outperforms state-of-the-art deep learning time-series forecasting models, such as LSTNet and FEDformer. WindCTD achieves an average 60.5% improvement over competitive models, with an average MSE of 0.0104 on a 12-hour-ahead WPF. Model interpretation using Integrated Gradients demonstrates that WindCTD successfully captures complex regional weather patterns. Model interpretation using the Integrated Gradients as shown below demonstrates that WindCTD successfully captures complex regional weather patterns. In addition to improved predictive accuracy over prior art models, the model is more computationally efficient and offers the potential to significantly improve wind power deployment and achievement of net-zero greenhouse gas emission goals.

Accurate wind power forecasting (WPF) is crucial for many reasons such as grid stability and energy management. In general, there are three main types of forecasting models: physical models, traditional statistical models, and artificial intelligence (AI) based models, see for example Wang et al. [2021]. Physical models, such as numerical weather prediction (NWP) models, rely on meteorological factors to make accurate predictions. However, these models have several limitations, including high computational costs and unsuitability for shorter forecasts due to time lags, see for example Espeholt et al. [2022]. To overcome these issues, deep learning (DL) models have emerged as an attractive alternative for WPF. DL models can learn the relationships between input observations and output variables directly from data, without the need to explicitly simulate the physics of the atmosphere.

Precise WPF involves considering multiple factors beyond weather patterns, such as equipment performance, maintenance schedules, grid faults, and individual turbine information. To address this high dimensionality, researchers have proposed various DL-based WPF models. For example Aslam et al. [2023] who used a dual-attention mechanism and Bayesian optimization to make multi-step ahead WPF based on historical wind power and weather features from the location of the wind farm. In Tian et al. [2022], the authors developed a DL-based WPF system that consists of five modules including a feature decomposition module to remove noise components and a dual-stage self-attention mechanism and gated recurrent unit layers to make the prediction. A framework using spatiotemporal attention networks for WPF is proposed by Fu et al. [2019] that contains a multi-head self-attention mechanism and a sequence-to-sequence model to capture spatial correlations among wind farms and temporal dependencies of wind power.

For short-term WPF based on meteorological features, Lu et al. [2022] developed a convolutional neural network (CNN) based approach and used long-short-term-memory (LSTM) layers for pre-diction. By considering the spatial location of turbines and their correlation with neighbors Li and Armandpour [2022] proposed a DL model, which integrates spatial and temporal dependencies using an encoder-decoder structured by gated-recurrent-unit (GRU) and multi-layer perception (MLP) layers. In Song et al. [2022], the authors proposed a graph convolution network (GCN) and a multiresolution CNN, combining spatial features and temporal features. To prepare the data, meteorological information from the location of the wind turbines and multiple features from the running state of the wind turbines (engine room temperature, gearbox bearing temperature, generator speed, etc.) were used.

In addition to the efforts made in the field of Wind Power Forecasting (WPF), the inventors wished to establish an architecture applicable to a broad range of Time Series Forecasting (TSF) applications. A deep learning framework, LSTNet, for multivariate TSF was proposed by Lai et al. [2018]. LSTNet uses a combination of convolutional and recurrent neural networks, along with an autoregressive component, to capture both short-term and long-term patterns in the data. An alternative prior art approach by Qin et al. [2017] proposed a dual-stage attention-based recurrent neural network (DA-RNN) approach for TSF that can adaptively select relevant input features and capture long-term temporal dependencies using an input attention mechanism and a temporal attention mechanism, respectively. Further, Grigsby et al. [2021] within another prior art approach introduced Spacetimeformer, a method that uses Long-Range Transformers to jointly learn temporal and spatial relationships for multivariate time series forecasting, without relying on predefined graphs.

Recent studies have demonstrated that while incorporating the transformer architecture, originally developed for natural language processing (NLP) tasks, see for example Vaswani et al. [2017], into TSF models has become popular, it may result in a loss of temporal information, see for example Zeng et al. [2022]. Despite several transformer-based TSF models being developed, including Informer (see Zhou et al. [2021]), FEDformer (see Zhou et al. [2022]), Autoformer (see Wu et al. [2021]), and Pyraformer (see Liu et al. [2021]), these models could not capture temporal dependencies effectively due to the permutation-invariant nature of the self-attention mechanism, see Zeng et al. [2022].

The use of transformers in TSF has gained popularity due to their superior long-term forecasting abilities and several transformer-based TSF models, such as Informer Zhou et al. [2021], FEDformer Zhou et al. [2022], Autoformer Wu et al. [2021], and Pyraformer Liu et al. [2021] have been developed within the prior art. However, some studies suggest that the permutation-invariant nature of self-attention in transformers may result in a loss of temporal information, see for example Zeng et al. [2022].

Accordingly, the inventors sought to address this issue and thereby outline below a solution for preserving temporal information within transformer-based TSF models which leverages cyclic time features to allow the transformer encoder to derive temporal information. Within the description outlined below the inventors address three objectives by way of outlining an embodiment of the invention. These three objectives with respect to wind power forecasting being:
accurately prediction of WPF for the next 12 hours of a wind farm based upon considering the meteorological features obtained from several weather stations spread over the region around the wind farm;
to effectively utilize multi-head self-attention attention whilst preserving temporal information; and
establish effect preparation of the data to extract the spatial and temporal features for WPF.

Accordingly, as will be evident from the embodiment of the invention described below the inventors have:
established a comprehensive end-to-end framework for WPF based on regional meteorological records and historical power generated;
established a framework and model that captures the complex meteorological patterns for high precision predictions of WPF;
assessed different preparation techniques and their effectiveness in WPF;
demonstrated the framework and model on two active wind farms and against seven state-of-the-art (SOTA) baseline algorithms wherein the inventors framework and model outperforms the SOTA models by an average of 60.5%; and
analysed what the model learnt using an Integrated Gradients method, see for example Sundararajan et al. [2017].

### Collecting Data

The model and framework established by the inventors was trained and evaluated using open-source meteorological and geographical data from 32 meteorological stations located throughout the province of Ontario, Canada. This provided a comprehensive coverage of the region within which the wind farms were situated. In order to address the extent to which climatological features can be utilized to predict wind power output the inventors also collected two wind power datasets from two active wind farms located in Ontario, Canada, from IESO, https://www.ieso.ca/en/Power-Data/Data-Directory (2023). In addition, the inventors obtained historical climate data covering the same region within a radius of approximately 600 km (approximately 370 miles) from the wind farms from the Government of Canada, “Historical Climate Data across Canada” https://climate.weather.gc.ca/ (2023). Further, the inventors obtained elevation information for each meteorological station and wind farm based on their latitude and longitude from the Elevation Point Query Service application programming interface of the United States Geological Survey (https://epqs.nationalmap.gov/). For the wind farms, the inventors considered the centric latitude and longitude of their 2D geometry.

Tables 1 and 2 provide a summary of the downloaded datasets and technical information for each wind farm.

TABLE 1
Wind Power Farm Data Description

| | Total | | | | | |
|---|---|---|---|---|---|---|
| | Project | Number | | | | |
| Project | Capacity | of | Data | Data | | |
| Name | (MW) | Turbines | Period | Frequency | Latitude | Longitude |
| Melancthon | 199.5 | 133 | January 2010 | Hourly | 44.09007435 | −80.30796273 |
| | | | to May 2021 | | | |
| Dufferin | 91.4 | 49 | January 2015 | Hourly | 44.21421872 | −80.25528307 |
| Wind | | | to May 2021 | | | |

TABLE 2
Meteorological Data Description

| | | Number of | Download | Data | Geographical |
|---|---|---|---|---|---|
| Data Type | Features | Stations | Data | Frequency | Location |
| Meteorological | Wind speed | 32 | January 2010 | Hourly | Varying |
| | Wind angle | | To | | |
| | Air pressure | | May 2021 | | |
| | Humidity | | | | |
| | Temperature | | | | |

### Data Processing

In order to capture the intricate weather patterns effectively within their framework and model the inventors employed multiple features including weather features, temporal features, and spatial features. An outline of the data processing steps is provided below which outlines how these features were obtained and processed.

### Historical Wind Power Data

The inventors cleaned and pre-processed the historical wind power dataset for each wind farm in two-steps. First, the abnormal behaviors in the dataset were flagged by identifying any negative or abnormally high values, as well as any uniform power output over the entire 24-hour period with zero fluctuation, and replacing them with Not a Number (NaN). Next, to normalize the data, the power output is divided by the installed capacity of the corresponding wind farm. Since no power output exceeds the maximum capacity of any wind farm, this normalization ensures that all power output values are on the same scale.

### Meteorological Data

In order to incorporate weather features into the inventors wind power forecasting model, the inventors applied a filtering process d to ensure the availability and quality of the data from meteorological stations. Specifically, only those stations with over 90% availability of wind speed, wind angle, air pressure, humidity, and temperature data were considered. The search for meteorological stations was limited to an approximately 600 km (approximately mile) radius from the wind farms within Ontario, Canada, resulting in the selection of 32 stations. To ensure the data quality, outliers and abnormal values, such as negative wind speeds and values outside of the reasonable ranges for each feature, were replaced with NaN. In the selected meteorological stations, any remaining missing values were filled using the corresponding feature at the same timestamp from another meteorological station, that in the closest vicinity. For each station, this process was repeated until all the missing values are filled for each station. Finally, each weather feature was normalized based on the maximum recorded value of that feature among all the meteorological stations in the region. FIG. 3 depicts the geographical location of the 2 wind farms 320 and 32 meteorological stations 310 used in the data set upon which the model was trained.

To fill in missing values in the weather station dataset, the inventors used the corresponding feature from the closest station at the same timestamp. The inventors continued this process until there were no missing values in the weather stations' dataset. Each weather feature was normalized based on the maximum recorded value of that feature among all the meteorological stations.

### Time Related Features

In order to incorporate time-related features into the wind power forecasting model, the inventors utilized the cyclic form of time features for hours, days, and weeks. Letting x be the value of the time unit to encode (hour, day, week), and letting n be the number of unique values in that time unit (e.g., 24 for hours, 31 for days, 52 for weeks). The cyclic encoding of x can be represented as shown below by Equations (1) and (2). These features were then normalized to range between 0 to 1.

$${sin}_{x} = sin \frac{2 π x}{n} \qquad ( 1 )$$

$${cos}_{x} = cos \frac{2 π x}{n} \qquad ( 2 )$$

### Spatial Features

To enhance the model's ability to capture spatial characteristics, the inventors incorporate additional features that describe the spatial relationships among the wind farms and meteorological stations. This being undertaken in several steps. First, the distance of each meteorological station from the wind farms was calculated using the haversine metric. Next, the elevation of each meteorological station and wind farm was established. Finally, using the wind farms as a referenced point, the circular angle (in radians) from each wind farm to each meteorological station was calculated. All the features are normalized to fall within the range of 0 to 1.

Normalizing each feature set separately ensures that the temporal and spatial aspects of the regional information are fully preserved. This approach helps the model learn the unique characteristics of each feature set while maintaining consistency in the overall range of values.

### Dealing With NaN Values and Data Split

With all the necessary features in hand, the inventors address the issue of missing values in the wind power data. The inventors first replace all corresponding feature values with NaN at the same timestamps where wind power is NaN, then treat the available data between each two NaN values as a separate time series to preserve the continuous behavior in each sequence. In the final processing step, the inventors split the dataset into training, validation, and test sets by considering one year (8711 samples) for each of the test and validation sets and the rest for the training set.

### Problem Formulation

The inventors examined four different data preparation techniques. All involve formatting the data sequentially where each original dataset comprises T timestamps and X features.

The first technique involves processing the data to generate xₙ∈R^{N×L×S×F} where N is the number of samples, L is the look-back length, S is the number of meteorological stations and the wind farm (33 in this case), and F represents the features at each timestamp L. The second technique formats the input data into a 3D shape with xₙ∈R^{N×L×SF}, where SF is obtained by flattening the third and fourth dimensions of the first technique.

The third and fourth approaches prepare the data for encoder-decoder based architectures where each expects a separate input. In the third method, the features are fed to the encoder, and the historical wind power is fed to the decoder with the shapes of xₙ∈R^{N×L×(S-1)F} and xₙ∈R^{N×L×1} respectively.

The fourth technique, see Zhou et al. [2021, 2022], Wu et al. [2021], Liu et al. [2021], involves the transformer encoder taking the same input as the second technique with the shape of xₑ∈R^{N×L×SF} along with the encoded time features for the same sequence whilst the decoder takes x_{d}∈R^{N×(LL+PL)×SF} as input along with encoded time features for the same time period. Here, LL denotes the label length, which is typically half of the look-back length, and PL represents the prediction length filled with zero values. xₑ and x_{d} denote the encoder and decoder inputs respectively.

### Model and Architecture

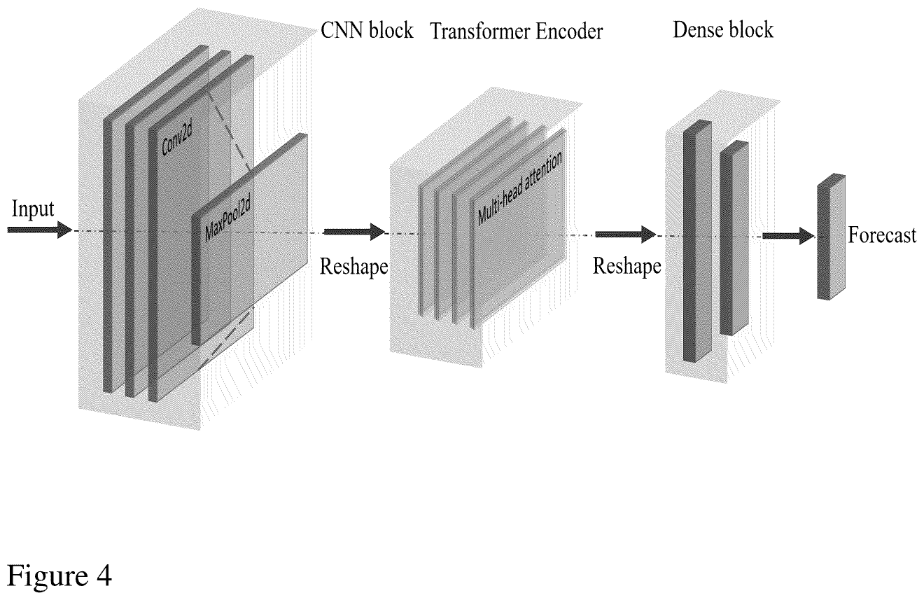

The proposed model contains three main blocks, a. CNN block, a Transformer Encoder, and a Dense block. FIG. 4 depicts the formation of the different blocks in the model.

CNN block: CNN block consists of 3 Conv2d layers with kernel sizes 1, 3 and 5respectively, followed by a MaxPool2d layer. The purpose of the Conv2d layers is to capture the spatial relationship between different stations. The input to the block is denoted by x∈R^{B×L×S×F} where B represents the batch size. The output of this block is flattened to create a 3D feature map for the transformer encoder with the shape of x∈R^{B×h}^{ₜ}^{×SF}, where hₜ is the reduced channel dimension created by the MaxPool2d layer. ReLU is used as the activation function and LayerNorm is applied to every CNN layer to normalize the outputs.

Transformer Encoder: The transformer encoder layer architecture used in this study is a standard architecture that consists of a multi-head self-attention module, see for example Vaswani et al. [2017]. As described above the inventors do not apply any sort of positional encoding and only rely on the temporal and spatial features added to the dataset. The transformer encoder layers expects the batch size to be the first dimension. The input of this block goes through 6 layers of the encoder with 8 multi-head self-attention layers and returns an output with the same shape as its input. Finally, a LayerNorm is applied to the output of the transformer encoder and the feature map is passed to the next block.

Dense Block: Before making the prediction, a 2-layer perceptron with ReLU activation function is utilized. The output features of each layer are 256 and 48, respectively. A dense layer with a linear activation function is then used to make the 12-hour predictive forecasts.

### Technical Details

As described above 4 different datasets are prepared for the benchmark models. All the datasets were prepared using 168 hours as the lookback time, 33 stations, and 15 features.

The training of WindCTD utilizes the Adam optimizer with a starting learning rate (LR) of 1×10−4, a batch size of 64, reducing LR patience of 3, a minimum LR of 7×10−6, and early stopping after 50 epochs. The model for which results are presented consisted of 6 transformer encoder layers, with a d_model of 256 and 8 heads for the multi-head self-attention. The mean squared error (MSE) was employed for training loss computation.

All experiments are conducted on a Linux Ubuntu operating system with a NVIDIA Corporation TU102GL [Quadro RTX 6000/8000] GPU and 64 GB of RAM.

### Experimental Results

### Benchmark Models

The benchmark models employed for comparison with WindCTD comprised the following. C1LSTMAtt, adapted from Zheng et al. [2020], is a Conv1d-LSTM model with an attention mechanism originally designed for capturing temporal and spatial features in traffic forecasting. VanillaLSTM, on the other hand, is a single-layer LSTM model. Both models employ a final linear dense layer for making forecasts. This study utilizes the wavelet variant of FedFormer, one of the two variants available. Additionally, LSTNet is implemented without the separate autoregressive component. The reader is referred to the Introduction for an overview of the other benchmark methods.

### Results and Discussion

The performance of WindCTD was compared against various benchmark architectures for 12-hour ahead WPF where the results are presented in Table 3. The results demonstrate the superiority of WindCTD over the benchmarks, highlighting an average improvement of 60.5% in MSE. Notably, WindCTD achieves MSE values of 0.0093 and 0.0116 for Melancthon and Dufferin Wind, respectively, while utilizing less than 20 million parameters.

In addition to the evaluation of performance metrics, Table 3 also offers valuable insights into the number of parameters, data type, and average epoch time for each model. The results shows the effectiveness of different data types in handling datasets with both spatial and temporal features. Specifically, data type 1 proves to be the most effective approach.

These additional details underscore the computational efficiency and training time of WindCTD compared to the benchmark models. It is important to note that all benchmark models underwent an extensive fine-tuning process, employing the same data pipeline methodology to ensure a fair and comprehensive evaluation of their performance.

TABLE 3
Baseline Algorithms Technical Information

| Algorithm | WINCTD | C1LSTMAtt | VanillaLSTM | LSTNet |
|---|---|---|---|---|
| Data Type | Type 1 | Type 1 | Type 2 | Type 2 |
| Number of Parameters | 16,864,372 | 1,567,532 | 314,518 | 511,935 |
| Average Epoch Time (s) | 88.0 | 74.5 | 21.5 | 20.0 |
| Melancthon MSE | 0.0093 | 0.0237 | 0.0241 | 0.0247 |
| Melancthon MAE | 0.0674 | 0.111 | 0.114 | 0.1143 |
| Dufferin Wind MSE | 0.0116 | 0.0296 | 0.0297 | 0.0294 |
| Dufferin Wind MAE | 0.071 | 0.0991 | 0.0989 | 0.0985 |

| Algorithm | DA-RNN | Informer | FEDformer | Transformer |
|---|---|---|---|---|
| Data Type | Type 3 | Type 4 | Type 4 | Type 4 |
| Number of Parameters | 337,208 | 5,393,665 | 102,319,129 | 807,073 |
| Average Epoch Time (s) | 345.0 | 78.5 | 557.0 | 33.5 |
| Melancthon MSE | 0.0277 | 0.0347 | 0.0374 | 0.0295 |
| Melancthon MAE | 0.1239 | 0.1407 | 0.1504 | 0.1294 |
| Dufferin Wind MSE | 0.0449 | 0.0577 | 0.0665 | 0.0483 |
| Dufferin Wind MAE | 0.1634 | 0.1912 | 0.2121 | 0.1719 |

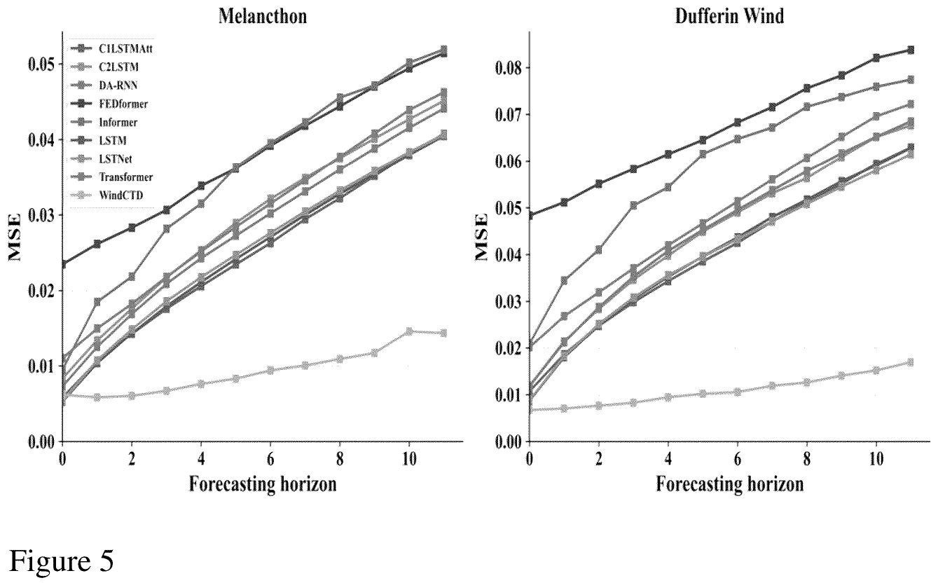

FIG. 5 presents the average MSE of each sample across the forecasting horizon, as evaluated by benchmark models and WindCTD, an embodiment of the invention. The results show that WindCTD achieves the best performance for the Dufferin Wind wind farm. However, it is noteworthy that the competitive nature of LSTM and LSTNet models is evident for short-term forecasting in the case of Melancthon wind farm. Although WindCTD exhibits a slightly inferior performance compared to these models in the short term, it emerges as the superior choice for longer forecasting horizons.

Importantly, WindCTD demonstrates a more stable forecast with reduced error divergence, indicating its ability to capture both temporal and spatial features effectively. These findings reinforce the model's robustness and reliability in accurately predicting wind power across extended time horizons.

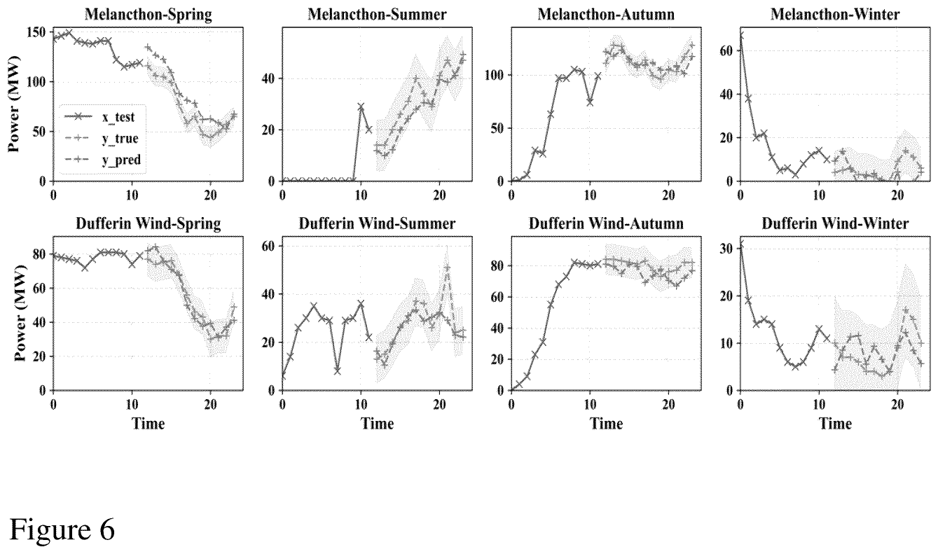

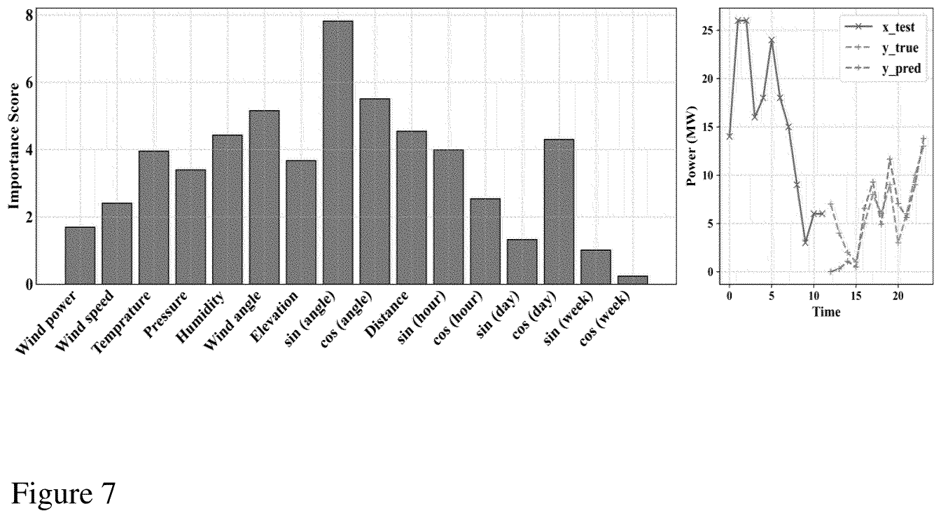

To further highlight WindCTD's performance across different conditions, FIG. 6 illustrates four samples selected from each season for each wind farm. Additionally, FIG. 7 presents a sample result of the Integrated Gradients method, highlighting the significance of various features in predicting the depicted sample. The analysis demonstrates the effectiveness of weather-related features, historical wind power, as well as spatial and temporal characteristics in the model's predictions.

For the illustrated sample, the angle of the wind farm to different stations emerged as the most important factor, along with elevation, weather features, hourly and daily time features, and historical wind power. Weekly temporal information, on the other hand, had the least importance. These findings align with the inherent relationships between weather features, wind farm output power, and the interplay between elevation, distance, and wind speed. By incorporating these factors, WindCTD effectively captures the intricate behavior of wind speeds within the region.

### Ablation Study

The ablation study conducted on WindCTD is presented in Table 4. In this study, different blocks of the model were removed to assess their individual contributions. The “No” tests indicate the absence of a specific block in that particular experiment. The results unequivocally demonstrate the significance of each block in WindCTD, as every block plays a crucial role in the model's overall performance.

Notably, the self-attention mechanism employed in WindCTD emerges as a particularly influential component. Its inclusion in the model significantly impacts the model's ability to capture temporal features, leading to a more stable and accurate long-term forecast. This highlights the importance of incorporating self-attention as a key element in WindCTD, underscoring its effectiveness in enhancing the model's predictive capabilities.

TABLE 4
Ablation study on 12-h-ahead forecasting

| Wind Farm Project | Melancthon | | | Dufferin Wind | | |
|---|---|---|---|---|---|---|
| Algorithms | WindCTD | NoCNNNoEnc | NoDense | WindCTD | NoCNNNoEnc | NoDense |
| MSE | 0.0093 | NaN 0.0248 | 0.0110 | 0.0116 | NaN 0.0298 | 0.0129 |

Within the description above the inventors have outlined a comprehensive framework for 12-hour-ahead WPF by leveraging regional weather features and historical wind power data. The raw datasets undergo extensive preprocessing and feature extraction, encompassing various temporal and spatial aspects. In order to capture the intricate regional weather patterns, an inventive model was established, referred to as WindCTD.

The performance of the proposed model was compared to several benchmark models using four different datasets prepared for each model. The results demonstrate the superior performance of the proposed model, with significantly improved forecast stability. Furthermore, the Integrated Gradients technique was employed to interpret the model's behavior and provide insights into its ability to capture complex weather patterns. This analysis further reinforces the model's effectiveness in capturing the intricate relationships between regional weather features and wind power generation.

The framework and model according to embodiments of the invention may be augmented by integrating specific facility information: Incorporating site-specific factors of wind farms, such as turbine characteristics and historical performance data can enhance the effectiveness of the proposed framework and model.

Whilst the framework and model according to embodiments of the invention were established and tested using data from wind farms and meteorological stations within the province of Ontario, Canada it would be evident that the framework and model according to embodiments of the invention are generalizable to other regions: Further, by including other regions the framework and model according to embodiments of the invention may be extended not only to wind power factor predictions of existing wind farms within diverse geographical regions with varying terrain and climate conditions but to employing the model to simulate different wind farms for planning purposes by modelling different location of the wind farms with historical meteorological data.

The inventors anticipated that further analysis of the effectiveness of different features and weather stations will lead to improved performance by refining feature selection but also by refining weightings given to different features.

Accordingly, the framework and model according to embodiments of the invention may be employed to improve the accuracy, applicability, and interpretability of WPF data ultimately supporting the integration of renewable energy sources into the power grid.

Accordingly, the inventors have developed an improved forecasting model utilizing only wind farm output power and meteorological data from weather stations located throughout the wind farms' region. The inventive deep learning architecture captures regional spatial information and weather patterns which are provided to a neural network, for example comprising a CNN block, Transformer Encoder and Dense Block, to establish a deep learning time-series forecasting model. The inventive model predicting a forward wind power factor, for example 1-hour or 12-hour although other predictive timeframes may be established. Beneficially, the deep learning time-series forecasting model successfully captures complex regional weather patterns as well as being computationally efficient.

It would be evident to one of skill in the art that the data obtained from the meteorological stations, which may be represented by Electronic Devices 204 in FIG. 2 may transmit data to a server, for example first and second Servers 195A and 195B respectively, wherein it is retrieved by a deep learning time-series forecasting model in execution upon another Electronic Device 204 or one of the first and second Servers 195A and 195B respectively. The resulting output from the deep learning time-series forecasting model may be transmitted from an Electronic Device 204 to the one of the first and second Servers 195A and 195B respectively when generated by the deep learning time-series forecasting model upon the Electronic Device 204 or it may be transmitted to an Electronic Device 204 or other server when generated by a deep learning time-series forecasting model in execution upon one of the first and second Servers 195A and 195B respectively.

The output from the deep learning time-series forecasting model may be employed by one or more enterprises, service providers, third-party providers, users, etc. in order to perform one or more actions. These one or more actions may be selected from the group comprising planning an activity, scheduling an activity, establishing pricing to consumers of the generated output, establishing outputs of generated power to an electrical grid (electrical supply) and electrical power storage (e.g, a battery, electrolysis for hydrogen-oxygen generation for subsequent regeneration etc.).

It would be evident that a deep learning time-series forecasting model according to an embodiment of the invention may be employed to generate two or more wind power factors for different forward predictive timeframes which are distributed to different users. For example, an electricity regulator may wish to simply have 12-hour predictions whereas an electricity provider (either directly associated with the wind farm or purchasing power from the wind farm) may wish to have 1-hour, 3-hour and 12-hour predictions.

Whilst the embodiments of the invention have been described with respect to hourly meteorological data it would be evident that the meteorological data acquired, processed and provided to a deep learning time-series forecasting model according to an embodiment of the invention may be at different sampling frequencies, e.g. every 5 minutes, every 15 minutes, hourly, two hourly etc. Similarly, the deep learning time-series forecasting model according to an embodiment of the invention may be executed at different frequencies such that the predictive wind power factors generated by it are updated.

The frequency may be upon acquisition of new meteorological data from all meteorological stations within a predetermined geofence relative to a wind farm upon which the deep learning time-series forecasting model according to an embodiment of the invention is applied, upon acquisition of new meteorological data from a subset of the meteorological stations within a predetermined geofence, e.g. 50% of the stations, 80% of the stations, etc., relative to a wind farm upon which the deep learning time-series forecasting model according to an embodiment of the invention is applied, or upon data acquired from a defined subset of the meteorological stations within a predetermined geofence relative to a wind farm upon which the deep learning time-series forecasting model according to an embodiment of the invention is applied changing by a defined threshold or thresholds. It would be evident that the deep learning time-series forecasting model according to an embodiment of the invention may simply execute at a predetermined frequency using the data within the database whether or not all or part of it has been updated.

Within embodiments of the invention the meteorological stations may store acquired data locally wherein it is retrieved by the deep learning time-series forecasting model directly or through an intermediate process that acquires the data and stores it within another memory or memories accessible to the deep learning time-series forecasting model.

Within embodiments of the invention the meteorological stations may push the acquired data to one or more memories remote from the meteorological stations wherein it is retrieved by the deep learning time-series forecasting model directly or through an intermediate process that acquires the data and stores it within another memory or memories accessible to the deep learning time-series forecasting model.

Within embodiments of the invention the meteorological stations employed in execution of the deep learning time-series forecasting model according to an embodiment of the invention for a particular wind farm may be defined by a geofence relative to the wind farm. Within embodiments of the invention the shape and size of the geofence may be static or it may be dynamic. If static, it may be established in dependence upon one or more factors, including but not limited to, target accuracy of prediction, target output of wind farm, number of wind turbines, layout of wind farm, etc. If dynamic, it may be established in dependence upon one or more factors, including but not limited to, atmospheric conditions, time of day, date, season, target accuracy of prediction, target output of wind farm etc.

Within the embodiments of the invention presented above spatial features are integrated to enhance the framework and model. These spatial features include the distance between each meteorological station and the wind farm and the elevations of each meteorological station and wind farm. These being employed to generate a single circular angle from each wind farm to each meteorological station was computed. However, it would be evident that wind farms can cover large areas of land or sea such that the turbines may be spread over significant distances and, potentially, on land different elevations.

Historically the typical spacing being roughly 7 times the rotor diameter but recent research suggests 15 times. Accordingly, using this basis wind turbines with 275 feet diameter (approximately 85 m) should be spaced approximately 3000 feet (approximately 900 m) or 0.6 miles (approximately 0.9 km) apart. Each such turbine generating 2 MW at wind speeds above 10 km/hr. (approximately 6 miles per hour).

Accordingly, within other embodiments of the invention a wind farm may be modelled as a series of segments where the spatial features are defined for each segment and the WPF predictions from the multiple segments combined to provide the overall WPF of the wind farm. Each segment may be defined by one or more factors, including for example, a particular geofence of defined geometry and size, a number of turbines, and a portion of a wind farm within defined elevation range. Each segment may therefore be considered a wind farm of a series of wind farms forming an overall wind farm.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of predicting an output of a wind farm comprising:
training a deep learning time-series forecasting model;
providing input data to the deep learning time-series forecasting model; and
establishing an output from the deep learning time-series forecasting model.

2. The method according to claim 1, wherein
the deep-learning time-series forecasting model is trained with a dataset comprising:
spatial information of a plurality of meteorological stations relative to the wind farm where the spatial information for each meteorological station of the plurality of meteorological stations comprises at least a distance of the meteorological station of the plurality of meteorological stations from the wind farm, an elevation of the meteorological station of the plurality of meteorological stations and an angle of the meteorological station of the plurality of meteorological stations relative to the wind farm;
acquired environmental measurements from each meteorological station of the plurality of meteorological stations over a period of time;
spatial information of a wind farm and elevation information for the wind farm; and
output information of the wind farm over the period of time; and
the environmental measurements from each meteorological station of the plurality of meteorological stations over the period of time and the output information of the wind farm over the period of time are time stamped.

3. The method according to claim 1, wherein
the deep learning time-series forecasting model comprises:
a convolutional neural network receiving data comprising a plurality of layers to capture the spatial relationship between the plurality of meteorological stations and the wind farm;
a transformer encoder comprising a number of encoder layers receiving the output of the convolutional neural network which relies upon temporal features and spatial features of the data fed to the deep learning time-series forecasting model; and
a dense block receiving output from the transformer encoder employing a linear-activation function to provide a forecast over a defined period to a defined future point in time; and
data for the deep learning time-series forecasting model is pre-processed to:
remove negative or abnormal values;
remove data for any periods of uniform power output over a defined duration, and
incorporate time-related features to address a self-permutation invariant nature of a self-attention mechanism within the deep learning time-series forecasting model by leveraging a cyclic form of the time related features.

4. A system comprising:
one or more microprocessors; and
one or more memories storing:
spatial information of a plurality of meteorological stations relative to the wind farm where the spatial information for each meteorological station of the plurality of meteorological stations comprises at least a distance of the meteorological station of the plurality of meteorological stations from the wind farm, an elevation of the meteorological station of the plurality of meteorological stations and an angle of the meteorological station of the plurality of meteorological stations relative to the wind farm;
acquired environmental measurements from each meteorological station of the plurality of meteorological stations over a period of time;
spatial information of a wind farm and elevation information for the wind farm; and
output information of the wind farm over the period of time; wherein
the one or more processors provide a deep learning time-series forecasting model;
the deep learning time-series forecasting model is trained using the spatial information of the plurality of meteorological stations, the environmental measurements from each meteorological station of the plurality of meteorological stations over a subset of the period of time, the spatial information of the wind farm and output information of the wind farm over the subset of the period of time;
providing to the deep learning time-series forecasting model environmental measurements from each meteorological station of the plurality of meteorological stations over another subset of the period of time; and
generating from the deep learning time-series forecasting model a prediction of the output of the wind farm for a predetermined forecast window from an end point of the period of time.

5. The system according to claim 4, wherein
the deep learning time-series forecasting model captures regional spatial information and weather patterns within a defined region around the wind farm.

6. The method according to claim 4, wherein
the deep-learning time-series forecasting model is trained with a dataset comprising:
spatial information of a plurality of meteorological stations relative to the wind farm where the spatial information for each meteorological station of the plurality of meteorological stations comprises at least a distance of the meteorological station of the plurality of meteorological stations from the wind farm, an elevation of the meteorological station of the plurality of meteorological stations and an angle of the meteorological station of the plurality of meteorological stations relative to the wind farm;
acquired environmental measurements from each meteorological station of the plurality of meteorological stations over a period of time;
spatial information of a wind farm and elevation information for the wind farm; and
output information of the wind farm over the period of time; and
the environmental measurements from each meteorological station of the plurality of meteorological stations over the period of time and the output information of the wind farm over the period of time are time stamped.

7. The method according to claim 4, wherein
the deep learning time-series forecasting model comprises:
a convolutional neural network receiving data comprising a plurality of layers to capture the spatial relationship between the plurality of meteorological stations and the wind farm;
a transformer encoder comprising a number of encoder layers receiving the output of the convolutional neural network which relies upon temporal features and spatial features of the data fed to the deep learning time-series forecasting model; and
a dense block receiving output from the transformer encoder employing a linear-activation function to provide a forecast over a defined period to a defined future point in time; and
data for the deep learning time-series forecasting model is pre-processed to:
remove negative or abnormal values;
remove data for any periods of uniform power output over a defined duration, and
incorporate time-related features to address a self-permutation invariant nature of a self-attention mechanism within the deep learning time-series forecasting model by leveraging a cyclic form of the time related features.

8. The method according to claim 4, wherein
the data employed in training the deep learning time-series forecasting model and generating the a prediction of the output of the wind farm is pre-processed to:
remove negative or abnormal values;
remove data for any periods of uniform power output over a defined duration, and
incorporate time-related features to address a self-permutation invariant nature of a self-attention mechanism within the deep learning time-series forecasting model by leveraging a cyclic form of the time related features.

9. A non-transitory storage medium storing computer executable instructions, the computer executable instructions when executed by one or more processors cause the one or more processors to execute a process comprising:
executing a deep learning time-series forecasting model;
training the deep learning time-series forecasting model with spatial information of a plurality of meteorological stations, environmental measurements from each meteorological station of the plurality of meteorological stations over a subset of a period of time, spatial information of a wind farm and output information of the wind farm over a period of time; and
generating from the deep learning time-series forecasting model a prediction of the output of the wind farm for a predetermined forecast window in dependence upon other environmental measurements from each meteorological station of the plurality of meteorological stations over another period of time.

10. The method according to claim 9, wherein
the process further comprises retrieving a dataset from one or more memories for training the deep-learning time-series forecasting model, the dataset comprising:
spatial information of a plurality of meteorological stations relative to the wind farm where the spatial information for each meteorological station of the plurality of meteorological stations comprises at least a distance of the meteorological station of the plurality of meteorological stations from the wind farm, an elevation of the meteorological station of the plurality of meteorological stations and an angle of the meteorological station of the plurality of meteorological stations relative to the wind farm;
acquired environmental measurements from each meteorological station of the plurality of meteorological stations over a period of time;
spatial information of a wind farm and elevation information for the wind farm; and
output information of the wind farm over the period of time; and
the environmental measurements from each meteorological station of the plurality of meteorological stations over the period of time and the output information of the wind farm over the period of time are time stamped.

11. The method according to claim 9, wherein
the deep learning time-series forecasting model comprises:
a convolutional neural network receiving data comprising a plurality of layers to capture the spatial relationship between the plurality of meteorological stations and the wind farm;
a transformer encoder comprising a number of encoder layers receiving the output of the convolutional neural network which relies upon temporal features and spatial features of the data fed to the deep learning time-series forecasting model; and
a dense block receiving output from the transformer encoder employing a linear-activation function to provide a forecast over a defined period to a defined future point in time; and
data for the deep learning time-series forecasting model is pre-processed to:
remove negative or abnormal values;
remove data for any periods of uniform power output over a defined duration, and
incorporate time-related features to address a self-permutation invariant nature of a self-attention mechanism within the deep learning time-series forecasting model by leveraging a cyclic form of the time related features.
